(19) United States
(12) Patent Application Publication
(10) Pub. No.: US 2017/0072608 A1
(43) Pub. Date: Mar. 16, 2017

(54) METHOD OF MANUFACTURING MOLDED PRODUCT WITH CONTROLLED DENSITY AND MOLDED PRODUCT MANUFACTURED BY THE SAME

(71) Applicants: Hyundai Motor Company, Seoul (KR); Kia Motors Corporation, Seoul (KR); Cell Form Co., Ltd., Incheon-si (KR); Hanmin Automotive Trim Industries, Cheongju-si (KR)

(72) Inventors: Jin Ho HWANG, Seoul (KR); Hong Mo KOO, Hwaseong-si (KR); Jang Hyun CHO, Incheon (KR); Jong Heon LEE, Suwon-si (KR); Chang Mo SEONG, Suwon-si (KR); Chun Gyun OH, Seoul (KR); Ho Dal LEE, Suwon-si (KR); Eun Kyeong LEE, Seoul (KR); Yeon Kwon SEO, Anyang-si (KR); Jung Jae SEO, Anyang-si (KR)

(73) Assignees: Hyundai Motor Company, Seoul (KR); Kia Motors Corporation, Seoul (KR); Cell Form Co., Ltd., Incheon-si (KR); Hanmin Automotive Trim Industries, Cheongju-si (KR)

(21) Appl. No.: 15/264,464

(22) Filed: Sep. 13, 2016

(30) Foreign Application Priority Data
Sep. 15, 2015 (KR) 10-2015-0130208

(51) Int. Cl. B29C 45/14; B29C 45/00; B29C 45/17

(52) U.S. Cl. CPC B29C 45/14508; B29C 45/14786; B29C 45/14795; B29C 45/174; B29C 45/0053; B29C 2045/14532; B29K 2023/12

(57) ABSTRACT

A method of manufacturing a molded product with controlled density may include preparing an upper layer outer sheath and a lower layer outer sheath of the molded product, manufacturing and preparing a filling material which forms a filling layer between the upper layer outer sheath and the lower layer outer sheath, positioning the lower layer outer sheath material in an internal space of a lower mold, disposing a temporary template on an upper portion of the lower mold to seal the internal space, and then injecting the filling material between the lower layer outer sheath material and the temporary template, removing the temporary template, and then positioning the upper layer outer sheath material on the injected filling material of the lower mold, and integrating the upper layer outer sheath material, the filling material, and the lower layer outer sheath material by heating and compression.

### CROSS-REFERENCE TO RELATED APPLICATION

The present application claims priority to Korean Patent Application No. 10-2015-0130208, filed Sep. 15, 2015, the entire contents of which is incorporated herein for all purposes by this reference.

### BACKGROUND OF THE INVENTION

Field of the Invention

The present invention relates to a method of manufacturing a molded product. More particularly, to a method of manufacturing a molded product, which is capable of improving durability of the molded product, reducing a loss of raw material, and manufacturing the molded product while variously adjusting density, weights, and thicknesses so that desired properties are exhibited for each portion, by adopting a method of molding the molded product by filling the inside of an outer sheath material with a filling material different from the outer sheath material.

Description of Related Art

In general, Styrofoam, urethane foam, and other various types of foam are widely used as interior materials such as a shock absorbing material, an acoustic absorbent material, an acoustic insulator, a thermal insulator, and a cushioning material. However, the foam materials are easily damaged because of low durability and low firmness thereof, and cause environmental problems when the foam materials are damaged.

Conventional Styrofoam plates are manufactured by a manufacturing method including a forming process of forming a fiber layer on one surface or both surfaces of Styrofoam foamed by foam chips made by mixing two types of materials selected from the group including polystyrene, polypropylene, polyethylene, and polyurethane, a heating process of heating the Styrofoam at a temperature of 120 to 250° C., and a pressing process of making a hard plate shape by applying pressure against the Styrofoam which has been subjected to the heating process, in which a joint layer is formed by stacking yarn made of at least one material, which is selected from the group including polystyrene, polypropylene, polyethylene, and polyurethane, has the same material as the Styrofoam material, and has a melting point lower than a melting point of the foam chip, onto the fiber layer, which has been subjected to the forming process, by using a carding machine (yarn carding machine), and by a publicly known heating process, the fiber layer and the Styrofoam are temporarily joined by stacking the fiber layer with the joint layer onto the Styrofoam, and the fiber layer and the Styrofoam, which are temporarily joined, are subjected to a publicly known pressing process and cooled, thereby forming the hard plate shape.

That is, the Styrofoam plate in the related art is manufactured by the aforementioned manufacturing method, such that the fiber layer made of non-woven fabric or woven fabric is integrated, by the joint layer, with upper and lower surfaces of the Styrofoam in a cross-sectional structure.

The Styrofoam plate in the related art, which is configured as described above, is easily used for a plate-shaped interior material having a predetermined thickness, but unsuitable to be used for an interior material having a curved surface shape.

Therefore, in the related art, in order to form and manufacture an interior material having an irregular shape such as a curved surface shape, an interior material having a desired shape is manufactured by manufacturing the Styrofoam plate in a plate shape having a thickness equal to a maximum thickness of the interior material, and then additionally heating and compressing the Styrofoam plate after the pressing process so that the Styrofoam plate is formed to have a curved surface.

However, in a case in which the interior material having the curved surface is manufactured by the aforementioned method, there is a problem in that because the curved surface of the interior material is formed by heating and compressing, a great loss of raw material occurs due to compression compared to a desired thickness.

In addition, because a desired curved shape is formed by heating and compressing the Styrofoam in a state in which the sheet-shaped fiber layer, which serves as an outer sheath, is joined to the Styrofoam, there is a problem in that stiffness varies for each portion.

That is, a part having a smaller thickness becomes a hard portion because this part is greatly compressed, and a part having a larger thickness becomes a soft portion because this part is relatively less compressed, and as a result, there are problems in that an unnecessary loss of material occurs and stiffness is insufficiently adjusted.

In a case in which durability is partially degraded because stiffness is not uniform overall and inadvertently varies partially as described above, there are problems in that the Styrofoam plate may be damaged by being broken or partially cut out even with minimal impact, and as a result, there is a limitation in using the Styrofoam plate as a product.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method of manufacturing a molded product, which is capable of improving durability of the molded product, reducing a loss of raw material, and manufacturing the molded product while variously adjusting density, weights, and thicknesses so that desired properties are exhibited for each portion, by adopting a method of molding the molded product by filling the inside of an outer sheath material with a filling material different from the outer sheath material.

According to various aspects of the present invention, a method of manufacturing a molded product with controlled density may include preparing an upper layer outer sheath material for use as an upper layer outer sheath of the molded product and a lower layer outer sheath material for use as a lower layer outer sheath of the molded product, as a sheet-shaped material, manufacturing and preparing a filling material which forms a filling layer between the upper layer outer sheath and the lower layer outer sheath of the molded product, positioning the lower layer outer sheath material in an internal space of a lower mold, disposing a temporary template on an upper portion of the lower mold to seal the internal space, and then injecting the filling material between the lower layer outer sheath material and the temporary template and filling between the lower layer outer sheath material and the temporary template, removing the temporary template, and then positioning the upper layer outer sheath material on the injected filling material of the lower mold, and integrating the upper layer outer sheath material, the filling material, and the lower layer outer sheath material by heating and compression, by compressing the filling material by moving the upper mold downward so that pressing is performed through the upper layer outer sheath material, in which a protruding portion having a predetermined height may be formed on at least a portion of a lower surface of the temporary template which is exposed to the internal space of the lower mold so that a height of the filling material between the lower layer outer sheath material and the temporary template varies due to the protruding portion for each portion of the lower surface of the temporary template, and density of the filling material is determined for each portion of the filling layer based on a height of the filling material after the forming process.

The upper layer outer sheath material may be manufactured by cutting polyethylene (PET) felt.

The lower layer outer sheath material may be manufactured as a cap-shaped plate having a lower surface portion and a lateral portion formed along a circumference of the lower surface portion by pressing a sheet in a mold in a state in which the sheet is heated.

The lower layer outer sheath material may be manufactured by pressing PET felt.

A filling material injection port of the lower mold through which the filling material is injected may be positioned at a higher position than that of an upper end of the lateral portion of the lower layer outer sheath material inserted into the internal space of the lower mold.

A flange portion may be formed along the upper end of the lateral portion of the lower layer outer sheath material, and a stepped parting portion on which the flange portion of the lower layer outer sheath material is placed may be formed on an inner surface of the lower mold.

The lower mold may be formed by coupling a first mold at an upper side and a second mold at a lower side thereof to form a single internal space in which the molded product is formed, the lower layer outer sheath material may be inserted into the internal space of the second mold, and the temporary template may be coupled to an upper portion of the first mold.

The parting portion may be formed on the lower mold by forming a stepped portion between an inner surface of the first mold and an inner surface of the second mold.

The protruding portions of the temporary template may be formed on the lower surface of the temporary template which is exposed to the internal space of the lower mold to have heights and shapes which are different for each portion of the protruding portions.

A steam injection port may be formed in the upper mold, and a steam process of supplying steam supplied from a steam supply device to the molded product between the upper mold and the lower mold by injecting the steam through the steam injection port during the forming process is performed.

The method may further include drying the molded product between the upper mold and the lower mold after the integrating; and detaching the molded product from the mold, in which the drying of the molded product may include suctioning and removing moisture, which may be supplied in the steam process, from the molded product through a suction tube connected to a suction inlet of the lower mold by using a vacuum pump.

The filling material may be manufactured by mixing the filling material and an adhesive binder, and the filling material comprises one foam chip made of polyurethane (PU), polypropylene (PP), polyethylene (PE), and as the filling material polystyrene (PS) is used or two or more foam chips made of polyurethane (PU), polypropylene (PP), polyethylene (PE), and polystyrene (PS) may be used after mixing the two or more form chips.

The filling material may be manufactured by mixing the filling material and an adhesive binder, and as the filling material, one material selected from polyurethane (PU) chips obtained by grinding polyurethane foam, PET felt ground products, fiber ground products, polyurethane single fibers, Styrofoam grains, waste fibers, and waste sponges may be used or two or more materials selected from polyurethane (PU) chips obtained by grinding polyurethane foam, PET felt ground products, fiber ground products, polyurethane single fibers, Styrofoam grains, waste fibers, and waste sponges may be used after mixing the two or more materials.

A liquid phase cohesive material made by mixing polypropyleneglycol (PPG), toluenediisocyanate (TDI), PP powder, or ceramic powder with a liquid may be used as the adhesive binder.

According to various aspects of the present invention, a molded product may include an upper layer outer sheath, a lower layer outer sheath, and a filling layer formed by a filling material between the outer and lower layer outer sheathes, in which the molded product may be manufactured by the manufacturing method including preparing an upper layer outer sheath material for use as the upper layer outer sheath of the molded product and a lower layer outer sheath material for use as the lower layer outer sheath of the molded product, as a sheet-shaped material, manufacturing and preparing the filling material which forms the filling layer between the upper layer outer sheath and the lower layer outer sheath of the molded product, positioning the lower layer outer sheath material in an internal space of a lower mold, disposing a temporary template on an upper portion of the lower mold to seal the internal space, and then injecting the filling material between the lower layer outer sheath material and the temporary template and filling between the lower layer outer sheath material and the temporary template, removing the temporary template, and then positioning the upper layer outer sheath material on the injected filling material of the lower mold, and integrating the upper layer outer sheath material, the filling material, and the lower layer outer sheath material by heating and compression, by compressing the filling material by moving the upper mold downward so that pressing is performed through the upper layer outer sheath material, in which a protruding portion having a predetermined height may be formed on at least a portion of a lower surface of the temporary template which is exposed to the internal space of the lower mold so that a height of the filling material between the lower layer outer sheath material and the temporary template varies due to the protruding portion for each portion of the lower surface of the temporary template, and density of the filling material is determined for each portion of the filling layer based on a height of the filling material after the forming process, and the filling layer may have a density of the filling material which is adjusted for each portion.

According to the method of manufacturing a molded product of the various embodiments of the present invention, it is possible to improve durability of the molded product, reduce a loss of raw material, and manufacture the molded product while variously adjusting density, weights, and thicknesses so that desired properties are exhibited for each portion, by adopting a method of molding the molded product by filling the inside of an outer sheath material with a filling material different from the outer sheath material.

In addition, the molded product according to various embodiments of the present invention may be variously used for an interior material or a part of the interior material for a vehicle, and may be widely used for an interior material or a part of the interior material for a vehicle that requires shock absorbing performance, acoustic absorbing performance, acoustic insulation performance, thermal insulation performance, cushion performance, and the like.

Furthermore, recyclable resources such as polyurethane chips may be used as the filling material that forms a filling layer between the upper layer outer sheath and the lower layer outer sheath which serve as skins of the molded product, and as a result, it is possible to reduce a weight of the product, and to reduce material costs and manufacturing costs.

The molded product according to various embodiments of the present invention may be variously used for an interior material or a part of the interior material for a vehicle, and particularly, the molded product may be widely used for an interior material or a part of the interior material for a vehicle that requires shock absorbing performance, acoustic absorbing performance, acoustic insulation performance, thermal insulation performance, cushion performance, and the like.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a process flowchart illustrating a process of manufacturing a molded product according to various embodiments of the present invention.

FIG. 2A and FIG. 2B are views illustrating an upper layer outer sheath material and a lower layer outer sheath material according to the present invention.

FIG. 3 is a schematic view illustrating a mold apparatus used during a process of manufacturing a molded product according to various embodiments of the present invention.

FIG. 4 is a schematic view illustrating a mold apparatus used during the process of manufacturing a molded product according to various embodiments of the present invention, in which a lower mold is configured as a two-stage mold.

FIG. 5 is a view exemplarily illustrating a temporary template according to the present invention.

FIG. 6 is a view for explaining a state in which density of a product molded by using the temporary template according to various embodiments of the present invention is adjusted for each portion.

FIG. 7 is a perspective view illustrating a shape of the product molded according to various embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Various embodiments of the present invention are directed to providing a method of manufacturing a molded product, which is capable of improving durability of the molded product, reducing a loss of raw material, and manufacturing the molded product while variously adjusting density, weights, and thicknesses so that desired properties are exhibited for each portion, by adopting a method of molding the molded product by filling the inside of an outer sheath material with a filling material different from the outer sheath material.

In various embodiments of the present invention, the molded product is formed and manufactured to have a plate shape, and may be manufactured in a plate shape having portions with different density, different weights, or different thicknesses, and the molded product may be variously used for an interior material or a part of the interior material for a vehicle.

In particular, the molded product may be widely used for an interior material or a part of the interior material for a vehicle which requires shock absorbing performance, acoustic absorbent performance, acoustic insulation performance, thermal insulation performance, cushioning performance, and the like, and for example, the molded product may be used for a lower end pad of a floor carpet.

In addition, recyclable resources such as recyclable ground chips collected from a waste automobile, for example, polyurethane (PU) chips, which are recyclable foam chips obtained by grinding PU foam collected from seats of a waste automobile as described below, polyethylene (PET) felt ground products, and other fiber ground products, may be used as a filling material which is formed as a filling layer between an upper layer outer sheath and a lower layer outer sheath which serve as skins of the molded product, and as a result, it is possible to reduce a weight of the product, and reduce material costs and manufacturing costs.

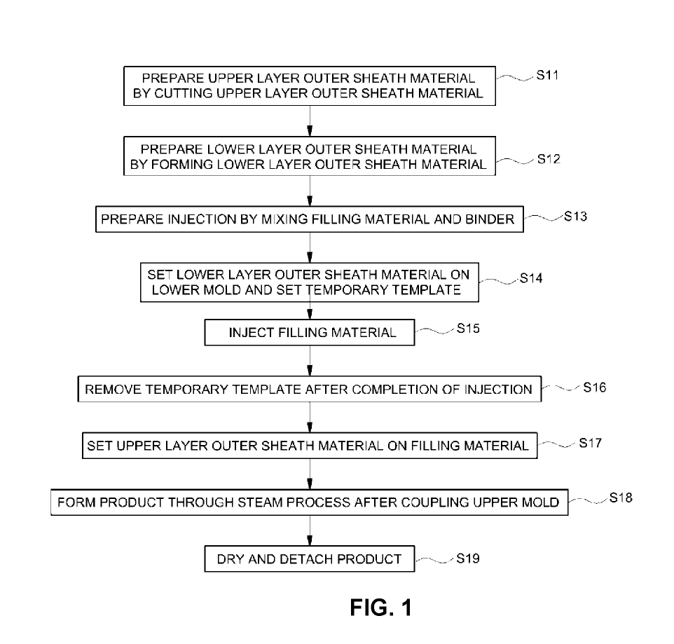

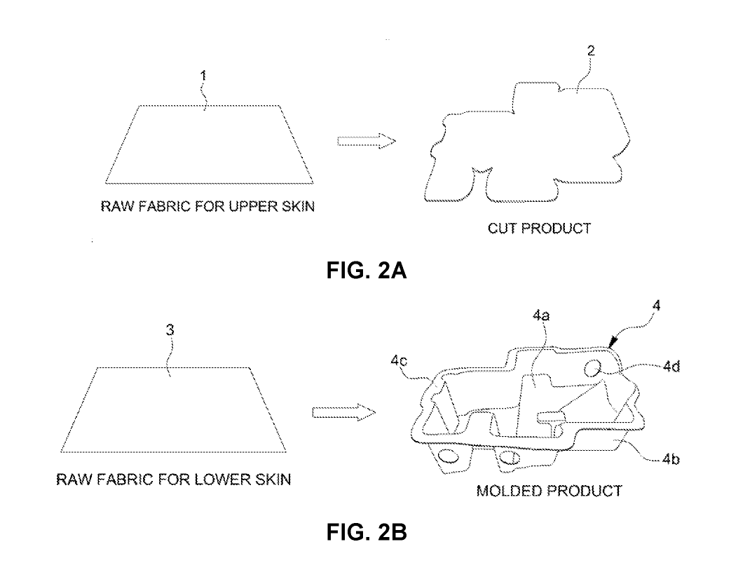

FIG. 1 is a process flowchart illustrating a process of manufacturing a molded product according to various embodiments of the present invention, FIGS. 2A and 2B are views illustrating an upper layer outer sheath material and a lower layer outer sheath material according to various embodiments of the present invention, and a manufacturing method according to the present invention will be described below with reference to FIGS. 1 and 2.

First, a raw fabric sheet 1 for a skin of a product is cut out in a shape required for a product, and thus a material 2, which is to be used for an upper layer outer sheath of the product, is prepared as illustrated in FIG. 2A (S11).

The prepared upper layer outer sheath material 2 is a sheet-shaped material used to form an upper surface portion of the product, that is, an upper skin of the product, and the upper layer outer sheath material may be manufactured by using PET felt.

Next, a raw fabric sheet 3 for another skin of the product is cut to a predetermined size, and then heated, and in this state, the raw fabric sheet 3 is pressed in a mold to have a shape required for the product, and thus a lower layer outer sheath material 4 is prepared as illustrated in FIG. 2B (S12).

The lower layer outer sheath material 4 is a sheet-shaped material used to form a lower surface portion of the product, that is, a lower skin of the product, and may be formed in a required shape by being heated and pressed in a press mold at a predetermined temperature and predetermined pressure, and the lower layer outer sheath material 4 may be manufactured as a cap-shaped plate having a lower surface portion 4a with a predetermined thickness, and a lateral portion 4b formed along a circumference of the lower surface portion.

In this case, the lower layer outer sheath material 4 may be formed by simultaneously heating and pressing the raw fabric in the press mold, but may be formed in a required shape by heating in advance the raw fabric by using an oven and then pressing the raw fabric in the press mold.

In addition, the lateral portion 4b of the lower layer outer sheath material 4 may be formed to approximately have an outer peripheral shape of the lower surface portion of the product and a lateral shape of the product, and the lower surface portion 4a may be formed to have a shape of a lower surface portion of the final molded product, for example, a shape that is stepped in height or curved for each portion as illustrated in FIG. 2B.

As the lower layer outer sheath material, PET felt may be used.

Further, a part at an upper side of the lateral portion 4b of the lower layer outer sheath material 4 illustrated in FIG. 2B is an unnecessary portion of the product, and therefore, the lower layer outer sheath material from which the unnecessary portion is cut and removed first may be subjected to the process of forming the product, but the unnecessary portion of the lower layer outer sheath material 4 may be removed by a trimming process during or after the forming process.

Next, the filling material is prepared by mixing the filling material and an adhesive binder in a mixing tank (S13). Here, as the filling material, polyurethane (PU) chips, PET felt ground products, cotton, and other fiber ground products may be used, recyclable resources such as polyurethane (PU) chips obtained by grinding polyurethane (PU) foam collected from a waste automobile may be used.

In addition, as the filling material, in addition to the PU chips and the PET felt ground products, foam chips of polypropylene (PP), polyethylene (PE), or polystyrene (PS), polyurethane single fibers, Styrofoam grains, polyurethane pieces, other waste fibers or waste sponges may be used either alone or in combination of selected materials.

As the foam chips, recyclable foam chips obtained by grinding foam may be used.

In addition, as the adhesive binder, a liquid phase cohesive material made by mixing polypropyleneglycol (PPG), toluenediisocyanate (TDI), or PP powder, or ceramic powder with a liquid may be used.

Further, one of publicly known adhesive binders may be adopted and used as long as the adhesive binder may integrally attach and fix the injected filling materials and completely ensure adhesiveness between the filling materials and the upper and lower layer outer sheath materials during the forming process to be described below.

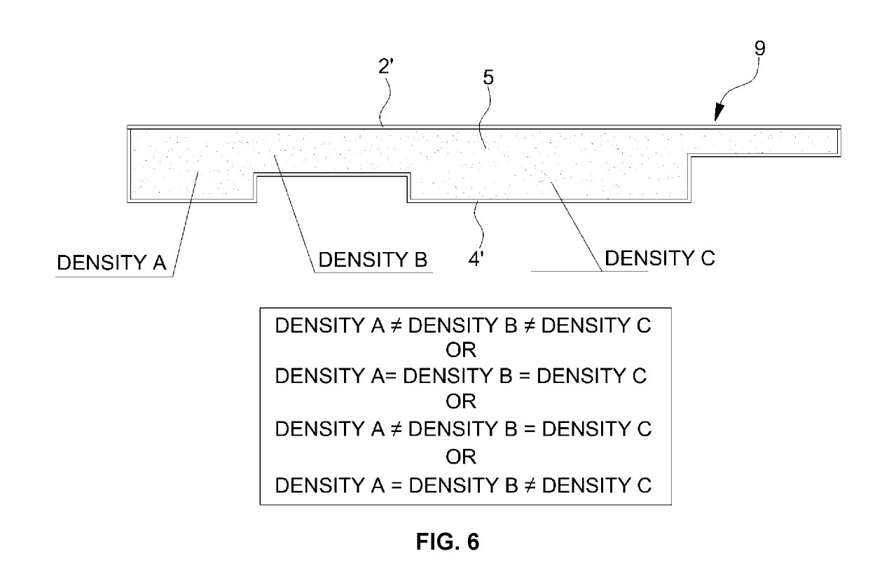

Next, by using the upper layer outer sheath material 2, the lower layer outer sheath material 4, and the filling material 5, which are prepared as described above, the molded product (reference numeral 9 in FIG. 6), which has outer sheaths (reference numerals 2′ and 4′ in FIG. 6) of an upper surface (upper skin) and a lower surface (lower skin) or outer sheaths of an upper surface, a lower surface, and a side surface, which are formed by using the upper layer outer sheath material 2 and the lower layer outer sheath material 4, and has an interior filled with the filling material, is formed and manufactured by using a mold.

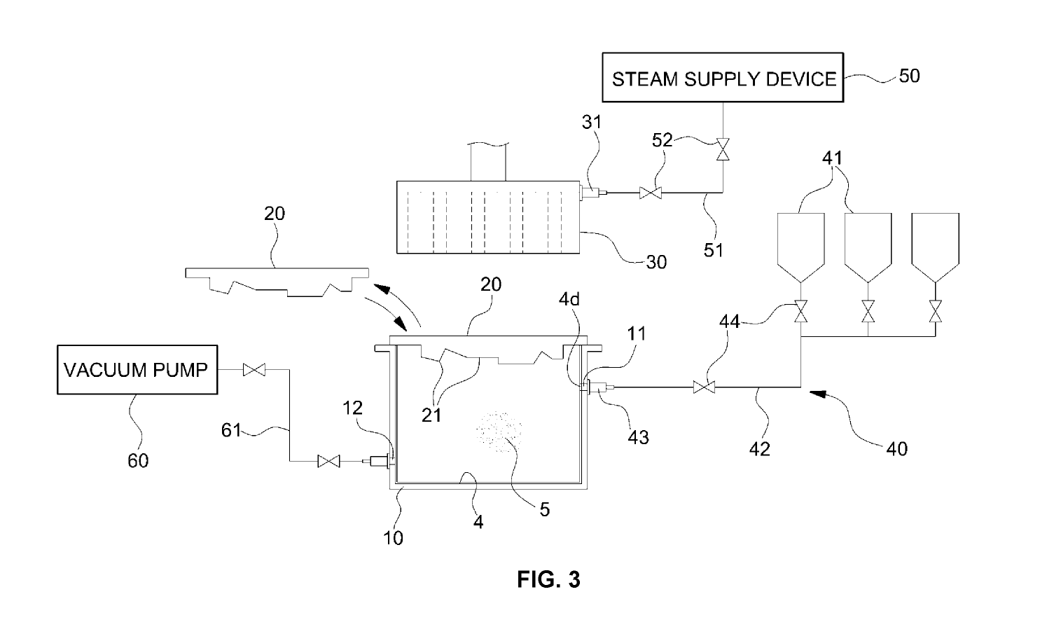

FIG. 3 is a schematic view illustrating a mold apparatus used for the process of manufacturing a molded product according to various embodiments of the present invention, and the mold apparatus includes a lower mold 10 which is configured to be filled with the lower layer outer sheath material 4 and connected to a filling device 40 so that the filling material may be injected into an internal space thereof, a temporary template 20 which is detachably coupled to an upper portion of the lower mold so as to seal the internal space between the temporary template 20 and the lower mold 10, and has protruding portions 21 which protrude at a preset height for each portion of the lower surface exposed to the internal space so that the filling amount (filling height) of the filling material injected into the internal space in the coupled state may be adjusted for each portion, and an upper mold 30 which is coupled to an upper portion of the lower mold 30 in a state in which the temporary template 20 is removed, forms a forming space with the lower mold 10, and presses, forms and integrates the upper layer outer sheath material 2, the lower layer outer sheath material 4, and the filling material 5 which are positioned in the forming space.

First, the filling device 40 includes a hopper 41, a filling material supply tube 42, a feeder 43, and valves 44.

In addition, a filling material injection port 11 is formed at one side of the lower mold 10, the feeder 43, which injects the filling material, is coupled to the filling material injection port 11, and the feeder 43 is connected to the hopper 41 into which the filling material is put through the filling material supply tube 42 through which the filling material is supplied.

A single or a plurality of hoppers 41 may be used.

Of course, in a case in which the plurality of hoppers 41 is used, the filling material supply tubes 42 connected to the respective hoppers may be merged and then coupled to the feeder 43 of the lower mold 10, and the valves 44, which open and close filling material supply passageways so as to selectively supply or block the supply of the filling materials put into the respective hoppers 41, are installed at predetermined positions of the filling material supply tube 42.

In addition, the internal space of the lower mold 10 is a space into which the pre-formed lower layer outer sheath material 4 is inserted, and as a result, the inner surface of the lower mold 10 needs to have a shape that may stably support and fix the lower layer outer sheath material 4 inserted into the internal space.

Therefore, although not illustrated in detail in the drawings, an inner bottom surface of the lower mold 10 may be formed in a shape which allows the lower surface portion 4a of the lower layer outer sheath material 4 to be supported in a contact state, that is, a shape considering a shape of the lower surface portion of the lower layer outer sheath material.

That is, in a case in which the shape of the lower surface portion of the lower layer outer sheath material 4 is curved, the inner bottom surface of the lower mold 10 may be formed in a shape which is matched (coincides) with the curved shape.

In FIG. 3, the formed lower layer outer sheath material 4 is simply illustrated as having a cap shape, but a shape of an actual lower layer outer sheath material may be variously changed, and as a result, a shape of the inner surface of the lower mold needs to be designed accordingly.

The temporary template 20 may be manufactured as a metallic plate which has the protruding portions 21 that have different heights and different shapes for each portion on one surface thereof, that is, the lower surface exposed to the internal space of the lower mold 10, and has a shape such that the temporary template 20 may seal the internal space of the lower mold after the lower layer outer sheath material 4 is inserted into the internal space of the lower mold 10 and then the temporary template 20 is coupled to the upper portion of the lower mold.

In a state in which the temporary template 20 is coupled to the upper portion of the lower mold 10 and seals the internal space of the lower mold, the space between the lower layer outer sheath material 4 and the temporary template 20, which is preset in the internal space of the lower mold, becomes a space into which the filling material 5 is injected and filled.

Therefore, there are height differences between positions of filling spaces because of height differences between portions of the protruding portion 21 (intervals between surfaces of the lower layer outer sheath material and surfaces of the protruding portions of the temporary template), and as a result, the amount of filling materials, which fill the spaces, may vary in accordance with the positions because of the height differences between the filling spaces.

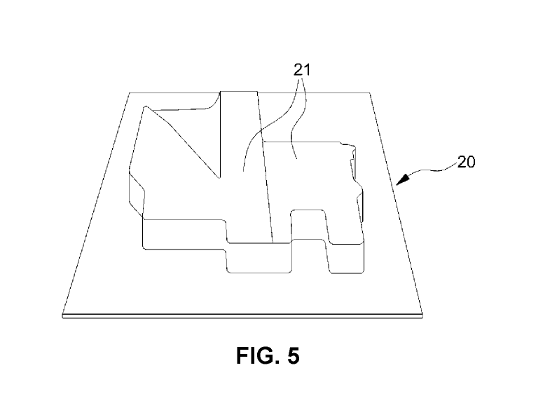

FIG. 5 is a view exemplifying the temporary template 20 and the protruding portions 21 formed on the lower surface of the temporary template 20, and the protruding portions 21 are formed at predetermined portions of the lower surface of the temporary template 20, and the height differences between the portions of the temporary template 20 where the protruding portions 21 are formed and portions where no protruding portion is formed may be set, and the height differences between the portions of the protruding portions 21 may be set.

When the temporary template 20 illustrated in FIG. 5 is reversed so that the protruding portions 21 are directed downward, and then the temporary template 20 is coupled to the upper portion of the lower mold 10, the internal space of the lower mold may be sealed, and the lower layer outer sheath material 4 is inserted and installed in advance into the internal space of the lower mold 10 (S14 in FIG. 1), the temporary template 20 is subsequently coupled to the upper portion of the lower mold 10 (S14), and then the filling material 5 is injected into the internal space of the lower mold 10 sealed by the temporary template 20 via the filling material injection port 11 (S15).

In this case, the space between the temporary template 20, the protruding portions 21 and the lower layer outer sheath material 4 are filled with the injected filling material 5, and in this case, the amount of filling materials varies in accordance with the positions in the internal space because there are height differences between the portions of the lower surface of the temporary template 20 due to the protruding portions 21 as described above.

Meanwhile, after the internal space is filled with the filling material and then the temporary template 20 is removed from the lower mold 10, the upper mold 30 is coupled to the upper side of the lower mold so as to heat, compress, and integrate the lower layer outer sheath material 4, the filling material 5, and the upper layer outer sheath material 2, thereby forming the product.

A steam injection port 31 is formed at one side of the upper mold 30, and a steam supply tube 51 is connected between the steam injection port 31 and a steam supply device 50.

In addition, valves 52, which open and close a steam supply passageway, may be installed in the steam supply tube 51 so that steam may be selectively supplied, and the steam supply device 50 may be a publicly known boiler apparatus that may supply the steam at an adjusted pressure and temperature.

As a result, after the filling process (S15 in FIG. 1) of inserting the lower layer outer sheath material 4 into the lower mold 10, coupling the temporary template 20, and filling the internal space with the filling material 5 is completed, the temporary template 20 is removed (S16 in FIG. 1), the upper layer outer sheath material 2 is positioned at an upper side of the internal space of the lower mold 10 so that the upper layer outer sheath material 2 is placed on the filling material 5 (S17), and thereafter, the upper mold 30 is moved downward so as to heat and press the lower layer outer sheath material 4, the filling material 5, and the upper layer outer sheath material 2 (forming by a steam process, S18).

In this case, the upper mold 30 is moved downward and inserted into the internal space of the lower mold 10 at a predetermined degree, such that the filling material 5 is compressed to have a thickness of the product, and pressed at a predetermined process temperature so that the upper and lower layer outer sheath materials 2 and 4 and the filling material 5 are joined to each other.

In particular, the steam supplied from the steam supply device 50 is injected into the molded product in the mold through the upper mold during the process of coupling and pressing the upper mold 30, and with the steam process, the upper layer outer sheath material 2, the filling material 5, and the lower layer outer sheath material 4 are joined to and integrated with each other by being heated and compressed while the upper mold 30 is pressed, and as a result, the upper layer outer sheath material 2, the filling material 5, and the lower layer outer sheath material 4 are formed to correspond to the shape of the product.

A pressing surface of the upper mold 30, which comes into contact with and presses the upper layer outer sheath material 2, may be a flat surface, and a certain portion of the pressing surface may protrude as necessary.

When the product is completely formed through the steam process as described above, the formed product is dried, and then the product is detached from the mold, and in this case, a suction tube 61 is connected to a suction inlet 12 in communication with the internal space of the lower mold 20, and the suction tube 61 is connected to a vacuum pump 60 in order to dry the product.

Therefore, a suction process of operating the vacuum pump 60 and suctioning and removing moisture, supplied from the steam process, from the molded product is carried out, and with the suction process, the molded product may be dried (S19).

When the process of drying the molded product including the suction process, is completed, the upper mold 30 is moved upward so as to open the mold, and then the formed product is detached from the mold (S19).

A trimming process of cutting and removing an unnecessary outer peripheral portion of the completely formed product may be carried out as necessary, and after the trimming process, the product is completely manufactured.

Of course, the trimming process may be manually carried out, but an automatic trimming process of cutting the unnecessary outer peripheral portion on the mold may be carried out.

In addition, the automatic trimming process may be carried out by using a separate trimming mold, but the automatic trimming process may be carried out at the same time when the forming process is carried out by using the upper mold 30 and the lower mold 10.

That is, cutting portions are provided on the upper mold 30 and the lower mold 10, an unnecessary portion of the molded product is automatically cut and trimmed by the cutting portions, when the upper mold is moved downward and coupled to the lower mold or when a pressing operation is performed by the upper mold in order to form a product.

In addition, in a case in which the upper layer outer sheath material 2 and the lower layer outer sheath material 4 are manufactured in consideration of an actual size of the product so as to have sizes that do not require the trimming operation, for example, in a case in which the outer sheath materials 2 and 4 are manufactured to have a size identical to an actual size of the product, the trimming operation of cutting an unnecessary outer peripheral portion after the forming process may be omitted.

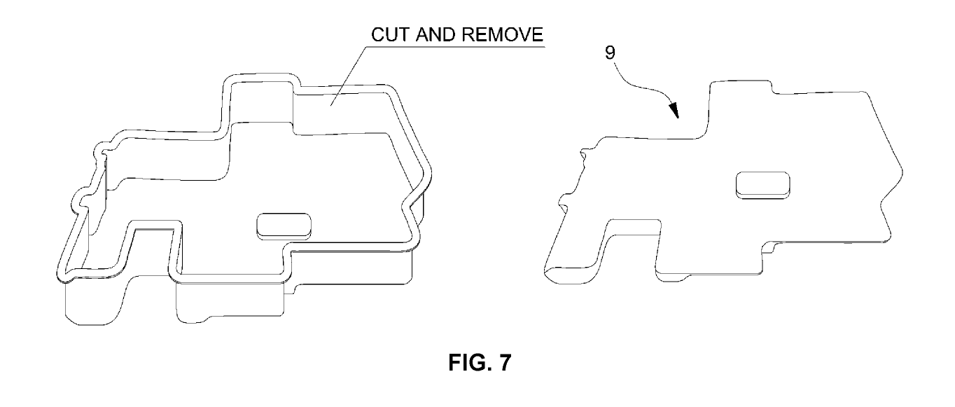

FIG. 6 is a view for explaining a state in which density of the product formed by applying the temporary template is adjusted for each portion, and FIG. 7 is a perspective view illustrating a formed product.

As illustrated in FIGS. 6 and 7, a molded product 9 in which a lower layer outer sheath 4′, an upper layer outer sheath 2′, and a filling material 5 are integrated may be manufactured by the aforementioned processes, and by changing the amount of filling materials in accordance with the portions by using the temporary template 20, density of a portion where a large amount of filling materials is injected, that is, where the filling materials are collected at a high height is relatively higher than that of other portions in a state in which the filling material is compressed by the upper mold 30.

In contrast, density of a portion where a small amount of filling materials is injected, that is, where the filling materials are collected at a relatively low height, is relatively lower than that of other portions in a state in which the filling material is compressed by the upper mold 30.

Therefore, in a case in which heights of the lower surface of the temporary template 20 or heights of the protruding portions 21 vary for each portion as described above, heights of upper surfaces of the filling materials vary for each portion, and thus, in a state in which there are height differences between the filling materials for each portion, the upper layer outer sheath material 2 is placed on the filling materials, and the upper layer outer sheath material is uniformly compressed by using the upper mold 30 having the flat pressing surface, and as a result, the molded product in which a weight and density of the filling material (e.g., PU) are adjusted for each portion of the product may be manufactured.

In addition to the adjustment of density, the molded product 9 having various thicknesses for each portion may be manufactured as illustrated in FIG. 6.

As a result, a product in which density, weights, and thicknesses are adjusted so as to exhibit desired properties for each portion may be manufactured, and in a case in which the product is used as an acoustic absorbent material for a vehicle, the acoustic absorbent material, which may exhibit different acoustic absorbent performance for each portion, may be manufactured.

As described above, in a case in which the product is used for a portion where noise, vibration, and harshness (NVH) performance is low, durability and NVH performance may be improved because density and the like may be freely adjusted for each portion of the product.

In addition, if the lower surface of the temporary template 20 is flat without having a protruding portion, an upper surface of the filling material becomes flat with a uniform height in a state in which the temporary template is removed after injection, and in this state in which the height of the filling material is uniform without a height difference for each portion, the upper layer outer sheath material 2 is placed on the filling material, and an overall surface of the upper layer outer sheath material is uniformly compressed by using the upper mold 30 having the flat pressing surface, and as a result, density of the filling material may become uniform without a difference for each portion.

In addition, when the molded product having different thicknesses for each portion is manufactured as illustrated in FIG. 6, the molded product may be manufactured such that density of the filling material may be uniform even though the filling material has different thicknesses, and in this case, the molded product may be manufactured by using the temporary template 20 having the protruding portions 21.

That is, if a shape of the temporary template 20 including the protruding portions 21 is designed, manufactured, and used as a shape in which the filling materials are collected at a relatively high height at a portion with a large thickness and the filling materials are collected at a relatively low height at a portion with a small thickness, density of the filling materials at the portion with a larger thickness and the portion with a smaller thickness may be adjusted to be at an equal level in a state in which an overall area of the upper surface of the upper layer outer sheath material 2 is uniformly pressed in a case in which the pressing surface of the upper mold 30 is flat and the upper layer outer sheath material 2 is a sheet-shaped material having no curved portion.

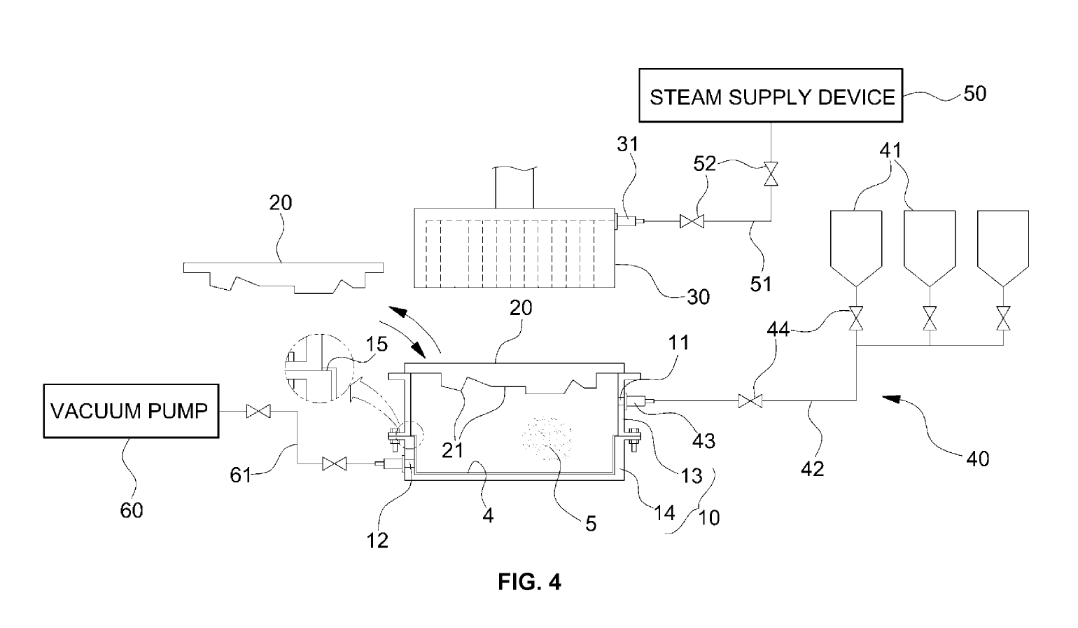

Meanwhile, FIG. 3 illustrates an example in which the lower mold 10 is manufactured by a single mold and used, but FIG. 4 illustrates an example in which a stepped parting portion 15 is formed on an inner surface of the internal space of the lower mold 10, and illustrates an example in which the lower mold 10 is manufactured as a two-stage mold obtained by coupling a first mold 13 at an upper side and a second mold 14 at a lower side so that the parting portion 15 may be formed and provided.

The first mold 13 and the second mold 14 are molds which are coupled to each other at the upper and lower sides so as to form a single internal space in the lower mold 10 where the product is formed, the lower layer outer sheath material 4 is inserted into the internal space of the second mold 14, and the temporary template 20 is coupled to the upper portion of the first mold 13.

In a case in which the lower mold 10 in FIG. 3 is used, a lateral portion 4b of the lower layer outer sheath material 4 needs to be formed at a higher height so that a flange portion 4c (illustrated in FIG. 2B), which is formed along an upper end of the lateral portion 4b (illustrated in FIG. 2B), may be disposed across an upper end of the lower mold, and as a result, a height of the upper end of the lateral portion 4b of the lower layer outer sheath material 4 is greater than a height of the filling material injection port 11 of the lower mold 10 through which the filling material 5 is injected.

A filling hole 4d (illustrated in FIG. 2B) needs to be manually formed in advance in the lateral portion 4b after the lower layer outer sheath material 4 is formed so that the filling material 5 may be injected through the filling material injection port 11 and the interior of the lower mold 10 may be filled with the filling material 5.

In addition, most parts of the lateral portion 4b of the lower layer outer sheath material 4 are unnecessary portions which are cut out and removed as illustrated in FIG. 7, and as a result, there may be problems in which a loss of materials is increased in a case in which the lateral portion is high, and wrinkled portions are formed due to an excessive height of the lateral portion when the product is formed.

In addition, when the filling material 5 is injected through the filling hole 4d, the filling material may penetrate between an outer surface of the lower layer outer sheath material 4 and an inner surface of the lower mold 10, and the formed product 9 may be contaminated by the filling material.

In contrast, in FIG. 4, the parting portion 15 is formed on the lower mold 10 by forming a stepped portion between the inner surface of the first mold 13 and an inner surface of the second mold 14.

Therefore, since the flange portion 4c (illustrated in FIG. 2B) of the upper end of the lateral portion 4b of the lower layer outer sheath material 4 may be put and placed on the stepped parting portion 15, it is possible to reduce a height of the lateral portion 4b of the lower layer outer sheath material 4, and as a result, it is possible to reduce a loss of materials and solve the problem of the occurrence of the wrinkled portions.

In addition, a position at which the filling material 5 is injected may be higher than a position of the lateral portion 4b of the lower layer outer sheath material 4 by positioning the filling material injection port 11 in the first mold 13, and as a result, it is not necessary to form a separate filling hole in the lateral portion of the lower layer outer sheath material, and thus it is possible to solve the problems of contamination caused by the penetration of the filling material.

In addition, a height of the lateral portion 4b of the lower layer outer sheath material 4 may be equal to a height of an actual product lateral portion, and in a case in which the cutting portion (which may be configured by providing a cutting blade at a portion corresponding to the flange portion), which cuts the flange portion 4c of the lower layer outer sheath material 4 when the upper mold 30 is pressed, is provided, separate trimming process after forming the product may also be omitted.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of manufacturing a molded product with controlled density, the method comprising:
preparing an upper layer outer sheath material for use as an upper layer outer sheath of the molded product and a lower layer outer sheath material for use as a lower layer outer sheath of the molded product, as a sheet-shaped material;
manufacturing and preparing a filling material which forms a filling layer between the upper layer outer sheath and the lower layer outer sheath of the molded product;
positioning the lower layer outer sheath material in an internal space of a lower mold, disposing a temporary template on an upper portion of the lower mold to seal the internal space, and then injecting the filling material between the lower layer outer sheath material and the temporary template and filling between the lower layer outer sheath material and the temporary template;
removing the temporary template, and then positioning the upper layer outer sheath material on the injected filling material of the lower mold; and
integrating the upper layer outer sheath material, the filling material, and the lower layer outer sheath material by heating and compression, by compressing the filling material by moving the upper mold downward so that pressing is performed through the upper layer outer sheath material,
wherein a protruding portion having a predetermined height is formed on at least a portion of a lower surface of the temporary template which is exposed to the internal space of the lower mold so that a height of the filling material between the lower layer outer sheath material and the temporary template varies due to the protruding portion for each portion of the lower surface of the temporary template, and density of the filling material is determined for each portion of the filling layer based on a height of the filling material after the forming process.

2. The method of claim 1, wherein the upper layer outer sheath material is manufactured by cutting polyethylene (PET) felt.

3. The method of claim 1, wherein the lower layer outer sheath material is manufactured as a cap-shaped plate having a lower surface portion and a lateral portion formed along a circumference of the lower surface portion by pressing a sheet in a mold in a state in which the sheet is heated.

4. The method of claim 3, wherein the lower layer outer sheath material is manufactured by pressing PET felt.

5. The method of claim 3, wherein a filling material injection port of the lower mold through which the filling material is injected is positioned at a higher position than that of an upper end of the lateral portion of the lower layer outer sheath material inserted into the internal space of the lower mold.

6. The method of claim 5, wherein a flange portion is formed along the upper end of the lateral portion of the lower layer outer sheath material, and a stepped parting portion on which the flange portion of the lower layer outer sheath material is placed is formed on an inner surface of the lower mold.

7. The method of claim 6, wherein
the lower mold is formed by coupling a first mold at an upper side and a second mold at a lower side thereof to form a single internal space in which the molded product is formed;
the lower layer outer sheath material is inserted into the internal space of the second mold; and
the temporary template is coupled to an upper portion of the first mold.

8. The method of claim 7, wherein the parting portion is formed on the lower mold by forming a stepped portion between an inner surface of the first mold and an inner surface of the second mold.

9. The method of claim 1, wherein the protruding portions of the temporary template are formed on the lower surface of the temporary template which is exposed to the internal space of the lower mold to have heights and shapes which are different for each portion of the protruding portions.

10. The method of claim 1, wherein a steam injection port is formed in the upper mold, and a steam process of supplying steam supplied from a steam supply device to the molded product between the upper mold and the lower mold by injecting the steam through the steam injection port during the forming process is performed.

11. The method of claim 10, further comprising:
drying the molded product between the upper mold and the lower mold after the integrating; and detaching the molded product from the mold,
wherein the drying of the molded product includes suctioning and removing moisture, which is supplied in the steam process, from the molded product through a suction tube connected to a suction inlet of the lower mold by using a vacuum pump.

12. The method of claim 1, wherein the filling material is manufactured by mixing the filling material and an adhesive binder, and the filling material comprises one foam chip made of polyurethane (PU), polypropylene (PP), polyethylene (PE), and
wherein as the filling material polystyrene (PS) is used or two or more foam chips made of polyurethane (PU), polypropylene (PP), polyethylene (PE), and polystyrene (PS) are used after mixing the two or more form chips.

13. The method of claim 1, wherein the filling material is manufactured by mixing the filling material and an adhesive binder, and as the filling material, one material selected from polyurethane (PU) chips obtained by grinding polyurethane foam, PET felt ground products, fiber ground products, polyurethane single fibers, Styrofoam grains, waste fibers, and waste sponges is used or two or more materials selected from polyurethane (PU) chips obtained by grinding polyurethane foam, PET felt ground products, fiber ground products, polyurethane single fibers, Styrofoam grains, waste fibers, and waste sponges are used after mixing the two or more materials.

14. The method of claim 12 , wherein a liquid phase cohesive material made by mixing polypropyleneglycol (PPG), toluenediisocyanate (TDI), PP powder, or ceramic powder with a liquid is used as the adhesive binder.

15. A molded product comprising:
an upper layer outer sheath;
a lower layer outer sheath; and
a filling layer formed by a filling material between the outer and lower layer outer sheathes,
wherein the molded product is manufactured by the manufacturing method comprising:
preparing an upper layer outer sheath material for use as the upper layer outer sheath of the molded product and a lower layer outer sheath material for use as the lower layer outer sheath of the molded product, as a sheet-shaped material;
manufacturing and preparing the filling material which forms the filling layer between the upper layer outer sheath and the lower layer outer sheath of the molded product;
positioning the lower layer outer sheath material in an internal space of a lower mold, disposing a temporary template on an upper portion of the lower mold to seal the internal space, and then injecting the filling material between the lower layer outer sheath material and the temporary template and filling between the lower layer outer sheath material and the temporary template;
removing the temporary template, and then positioning the upper layer outer sheath material on the injected filling material of the lower mold; and
integrating the upper layer outer sheath material, the filling material, and the lower layer outer sheath material by heating and compression, by compressing the filling material by moving the upper mold downward so that pressing is performed through the upper layer outer sheath material,
wherein a protruding portion having a predetermined height is formed on at least a portion of a lower surface of the temporary template which is exposed to the internal space of the lower mold so that a height of the filling material between the lower layer outer sheath material and the temporary template varies due to the protruding portion for each portion of the lower surface of the temporary template, and density of the filling material is determined for each portion of the filling layer based on a height of the filling material after the forming process, and
wherein the filling layer has density of the filling material which is adjusted for each portion.
